(19) United States
(12) Patent Application Publication
(10) Pub. No.: US 2024/0296109 A1
(43) Pub. Date: Sep. 5, 2024

(54) SYSTEMS AND METHODS FOR TESTING, TRAINING AND INSTRUCTING AUTONOMOUS VEHICLES

(71) Applicant: ROBOCARS INC., Pittsburgh, PA (US)

(72) Inventors: Ragunathan RAJKUMAR, Monroeville, PA (US); Sandeep D'SOUZA, Pittsburgh, PA (US); Anand BHAT, Pittsburgh, PA (US)

(21) Appl. No.: 18/260,171

(22) PCT Filed: Dec. 20, 2021
(86) PCT No.: PCT/US2021/064353

§ 371 Date: Jun. 30, 2023

Related U.S. Application Data
(60) Provisional application No. 63/132,032, filed on Dec. 30, 2020.

(51) Int. Cl. G06F 11/36; G06N 20/00

(52) U.S. Cl. CPC G06F 11/3688; G06N 20/00

(57) ABSTRACT

Systems and methods for testing, training, and instructing autonomous vehicles (AVs) are described herein. In one aspect, a computer-implemented method for live testing an AV including generating one or more test objects from a stored set of test objects, test object attributes, or a combination thereof; superimposing the one or more test objects on sensory data received from one or more sensors of the AV and corresponding to an external environment of the AV; and testing one or more software subsystems of the AV, in a manual mode, a partially autonomous mode or a fully autonomous mode, with the sensory data after superimposition.

### CROSS-REFERENCE TO RELATED APPLICATION

This application claims priority under 35 U.S.C. § 119(e) to U.S. Provisional Patent Application No. 63/132,032, titled “Systems and Methods for Testing, Training and Instructing Autonomous Vehicles,” and filed Dec. 30, 2020. The entire content of this application is hereby incorporated by reference herein.

### BACKGROUND OF THE INVENTION

Autonomous vehicles (AVs) are vehicles that can operate themselves without the need for operation by a human driver. AVs, like normal, human-driven vehicles, encounter unique road scenarios regularly. Training AVs to autonomously drive and make decisions is a burdensome task that requires on-road training with typically a human operator to intervene, adjust or reinforce the AVs decision-making processes or outcomes. To ensure safe operations during eventual deployment, the training also must also incorporate real-world scenarios and obstacles, which can lead to potentially dangerous situations, particularly before the technology has matured and become dependable. Also, simulating and testing AV behavior in purely virtual scenarios does not capture the dynamics and complexities of the real world. Hence, there exists a need for systems and methods for testing and training AVs while mitigating the dangers and reducing the costs associated with real-world scenario training.

### SUMMARY OF THE INVENTION

Systems and methods for testing, training, and instructing autonomous vehicles (AVs) are described herein. In one aspect, a computer-implemented method for live testing an AV including generating one or more test objects from a stored set of test objects, test object attributes, or a combination thereof; superimposing the one or more test objects on sensory data received from one or more sensors of the AV and corresponding to an external environment of the AV; and testing one or more software subsystems of the AV, in a manual mode, a partially autonomous mode or a fully autonomous mode, with the sensory data after superimposition.

This aspect can include a variety of embodiments. In one embodiment, each test object emulates raw sensory data, the output after the sensory data has been processed, or a combination thereof. In some cases, the method can further include displaying, via one or more display interfaces of the AV, the sensory data; and displaying, via the one or more display interfaces of the AV, the sensory data after superimposition of the test objects.

In another embodiment, the method can further include generating the one or more test objects from one or more computers located inside the AV, from one or more computers located outside the AV and communicating to the AV, or a combination thereof.

In another embodiment, the method can further include determining one or more positions within the sensory data, where the one or more test objects are each superimposed at a respective determined position.

In another embodiment, the one or more sensors include one or more vision cameras, one or more night vision cameras, one or more LIDARs, one or more RADARs, one or more ultrasonic sensors, one or more microphones, one or more vibration sensors, one or more locating devices, or a combination thereof.

In another embodiment, the method can further include incorporating a set of attributes of each test object into the superimposition, the set of attributes including an appearance, a classification, a bounding box, an outline, a location, a speed, a direction, partial or complete visibility, or a combination thereof. In some cases, the method can further include determining the set of attributes of each test object as a function of time, location, relative distance from the AV, speed of the AV, direction of the AV, one or more other test objects in the vicinity, surrounding objects in the external environment, or a combination thereof.

In another embodiment, each test object can include a vehicle, a pedestrian, a bicyclist, a rider, an animal, a bridge, a tunnel, an overpass, a merge lane, a train, a railroad track, railway gates, a construction zone artifact, a construction zone worker, a roadway worker, a road boundary marker, a lane boundary marker, a road obstacle, a traffic sign, a road surface condition, a lighting condition, a weather condition, an intersection controller, a tree, a pole, a bush, a mailbox, of a combination thereof.

In another embodiment, testing one or more AV software subsystems can further include determining, by the one or more software subsystems, an identification of at least one of the one or more test objects; determining, by the one or more software subsystems, a position of the at least one test object within the superimposed sensory data, the external environment, or a combination thereof; and determining, by the one or more software subsystems, a future trajectory of the test object within the sensory data after superimposition, the real-world environment, or the combination thereof. In some cases, the method can further include generating one or more actuation commands for one or more actuation subsystems of the AV based on the determined identification, the determined position, the determined trajectory, or a combination thereof; and storing the one or more actuation commands generated by the one or more AV software subsystems.

In another embodiment, the method can further include storing, checking, verifying, validating, or a combination thereof, a set of decision processes undertaken by the one or more software subsystems during the testing.

In another embodiment, the method can further include determining a set of attributes for the one or more test objects; where the set of attributes include a time of birth on an absolute timeline, a time of birth on a relative timeline, a time of birth at an absolute position within the sensory data or external environment, a time of birth position within the sensory data or external environment relative to the AV; a time of birth at an absolute speed of movement; a time of birth at a speed of movement relative to a speed of the AV; a time of birth movement along an absolute direction; a time of birth movement along a direction relative to a direction of travel of the AV; a time of birth position relative to other objects; a time of demise on an absolute timeline; a time of demise on a relative timeline; a time of demise at an absolute location; a time of demise at a location relative to the AV; a time of demise at an absolute speed; a time of demise at a speed relative to a speed of the AV; a time of demise along an absolute direction, a time of demise along a direction relative to a direction of travel of the AV; a time of demise position relative to other objects, a number of re-generation for the test object; a frequency for re-generation of the test object, a movement status for the test object, a behavior pattern for the test object corresponding to other test objects, a behavior pattern for the test object relative to objects within the external environment, a behavior pattern for the test object relative to the AV, or a combination thereof.

In another embodiment, the sensory data can include a front view from the AV, one or both side views from the AV, a rear view from the AV, or a combination thereof.

In another aspect, a non-transitory, computer-readable media of an AV including one or more processors; a memory; and code stored in the memory that, when executed by the one or more processors, cause the one or more processors to: display, via one or more display interfaces of the AV, sensory data received from one or more sensors of the AV; generate one or more test objects from a stored set of test objects or test object attributes; superimpose the test object on the sensory data; and test one or more software subsystems of the AV with the superimposed sensory data.

In another aspect, a computer-implemented method for super-imposing data of an AV includes receiving sensory data from the AV; receiving, in response to the sensory data, an operator command for altering AV driving behavior, route, path, speed, vehicle status, or a combination thereof; generating, in response to the operator command, one or more test objects from a stored set of test objects, test object attributes, or a combination thereof; and super-imposing the one or more test objects on the sensory data.

This aspect can include a variety of embodiments. In one embodiment the method can further include receiving the operator command from a remote operator station, an occupant of the AV, or a combination thereof.

In another embodiment, receiving the operator command can include receiving input via an input interface including a wireless communications interface, a touchscreen, a switch, a button, a knob, a keyboard, a computer mouse, a drawing pad, a camera, a microphone, or a combination thereof.

In another aspect, a computer-implemented method for testing and instructing one or more AVs from one or more remote computers can include transmitting to a plurality of AVs a first set of route information where test objects may require superimposition on to sensory datastreams of the plurality of AVs; receiving from one or more AVs a second set of route information; determining from the second set of route information a group of AVs subject to at least one test object that requires superimposition on the respective AV's sensory datastreams; and broadcasting to the group of AVs a list of data objects that must be superimposed based on the determining.

In another aspect, a computer-implemented method for testing and instructing one or more AVs from one or more remote computers can include receiving from the one or more remote computers one or more requests for AV route information; transmitting to the one or more remote computers route information of the AV; receiving instructions to superimpose test objects; and processing the remote instructions to superimpose the test objects as specified.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 depicts an autonomous vehicle (AV) according to an embodiment of the claimed invention.

FIG. 2 depicts a communication swim diagram for an AV, according to an embodiment of the claimed invention.

FIG. 3 depicts a software subsystem for an AV according to embodiments of the claimed invention.

FIG. 4 depicts a system for image superimposition for an AV according to an embodiment of the claimed invention.

FIGS. 5-18 depict examples of test objects added to the sensory datastreams received by an AV according to embodiments of the claimed invention. FIG. 5 shows a group of youngsters being superimposed along an urban road on a camera datastream sensed by an AV. FIG. 6 illustrates motor cyclists being superimposed in a highway scenario. FIG. 7 depicts a bevy of deer along a rural road being superimposed along a rural road. FIG. 8 illustrates the superimposition of construction zone artifacts like cones, barrels and a barrier along an urban thoroughfare. FIG. 9 depicts the superimposition of a flagman, a bicycle and a vehicle as bounding boxes with their corresponding classifications into a camera datastream. FIG. 10 shows the superimposition along icy roads of a pedestrian, and two other test objects represented as bounding boxes with one classified as a pedestrian and another classified as a vehicle. FIG. 11 illustrates the superimposition of the effects of rainy weather in a camera datastream. FIG. 12 shows the superimposition of two bicyclists in foggy weather in a camera datastream. FIG. 13 depicts the illustration of a deer and a bounding box classified as a pedestrian in a camera datastream at night. FIG. 14 illustrates the superimposition of a vehicle and the bounding box of a truck in a lidar datastream received by the AV. FIG. 15 shows the superimposition of a deer, a car and a bounding box classified as a vehicle in the front night vision datastream of an AV. FIG. 16 depicts a 3-D real-world model of the AV's surrounding environment with two superimposed objects on the center console display of an AV which is shown in white near the center of the display. FIG. 17 illustrates two superimposed radar objects on the center console display of the AV with the two radar objects corresponding to the physical locations shown in the camera image of the road in front of the AV. FIG. 18 shows how one or more remote computers can broadcast or selectively multicast to one or more AVs test objects to be superimposed on their respective sensory datastreams.

### DEFINITIONS

The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

Systems and methods for testing and training autonomous vehicles are described herein. AVs are conventionally tested and trained in two ways. First, an AV simulator is used to generate a range of road scenarios with traffic and obstacles, and the AV software is used to control a virtual AV in the simulated environment. Secondly, the AV is tested on roads with real-world traffic on public roads or with controlled traffic on private roads and lots. The simulation approach is useful for testing certain AV software functions but it does not truly capture the wide range of dynamics and complexities of the real world. On-road testing can be realistic with real-world scenarios, such that AVs encounter scenarios and/or objects while on a roadway. AVs sense these scenarios, determine decisions in response to the scenarios, and initiate the decisions generally through an actuation subsystem of the AV. During training, an operator can intervene if necessary and supervise the AVs decision-making and response processes, which can include reinforcing or overriding these processes. However, simply using real-world scenarios can introduce a degree of danger for both the AV (and passengers of the AV, such as the operator) as well as people and animals included in the real-world scenario. Some scenarios such as ones with young children, disabled pedestrians and wild animals on the roadway are also very risky propositions to test, and repeatability is a major concern even after any required fixes are made.

According to embodiments of the claimed invention, a computer system can superimpose information about test objects into one or more sensory datastreams received by an AV. The computer system can relay these aggregated sensory datastreams (data sensed by the physical sensors on the data and the superimposed data about test objects) back to the decision-making subsystems/components of the AV for responding to the AV's real-world environment. These AV components can then react to the aggregated sensory datastreams as if the superimposed data are being experienced by the AV in the real world. Thus, the AV can react to test objects of various kinds and motion profiles without necessarily running into the situations in the real-world. This can reduce the dangers associated with training AVs by encountering real-world objects. For example, if the presence of a child or an elderly person on the road ahead is superimposed on the datastreams received by an AV, the AV needs to react safely. In case of any malfunction, nobody gets hurt. The AV itself may not be damaged either. After the malfunction is fixed, the same scenario can then be repeated again without exposing any vulnerable road user to additional risk. The test objects can be stationary or in motion. Stationary test objects can be placed in pre-specified absolute locations on the roadway, or at locations relative to the current position of the AV. Similarly, test objects in motion can pick from pre-specified motion profiles which specify the path and speed of each object, or react in different ways based on the behavior of the AV itself. These test objects can also be located at multiple locations around the AV and be superimposed into the sensory streams surrounding the AV.

Further, in some cases the computer system can superimpose sensory data which can cause the AV to react in a predetermined way. For example, the computer system can receive instructions, or alternatively make a decision, to guide the AV to or from a location. The computer system can superimpose a generated obstacle at a particular position of the AV's sensory datastreams, which the AV can either avoid (e.g., a large rock), or go towards (e.g., a road sign, a construction worker waving the AV towards a particular direction, etc.). As the computer system can identify generally how the AV will react to particular superimposed sensory data, the computer system can implement these generated sensory data to indirectly guide or control the AV.

An AV may use a Global Navigation Satellite System (GNSS), such as the Global Positioning System (GPS), to help determine its position on the planet and guide its journey toward a destination. In this case, AV software will receive GNSS and any auxiliary data as a datastream. According to one embodiment of the invention, information can be superimposed on the GNSS datastream fed to the AV in order to test and train the behavior of the AV when GNSS data are not available or is particularly noisy.

The disclosure provided herein can be applied to intelligent vehicles of all kinds, including AVs (e.g., also known as self-driving or driverless vehicles), vehicles with advanced driver assist systems (ADAS), and the like.

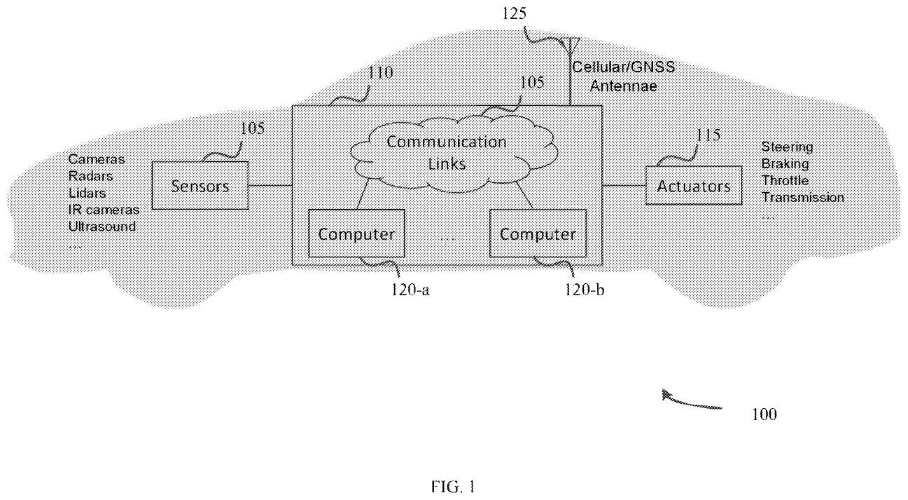

FIG. 1 depicts an AV 100 according to an embodiment of the claimed invention. The AV 100 can include one or more sensors 105, a software subsystem 110, and an actuator subsystem 115. Although shown as an image of car, the AV can be a multitude of vehicles, such as passenger vehicles, freight vehicles, mass transit vehicles, delivery vehicles, military vehicles, rail vehicles, airborne vehicles, water surface vehicles, underwater vehicles, and the like.

The sensors 105 of the AV can capture or receive data corresponding to the external environment. The sensor(s) 105 can be equipped on the exterior and/or the interior of the AV 100. For example, sensors 105 can be located on the windshield, the front bumper, the rear bumper, the rear windshield, a passenger or driver door, the fenders, the roof, the undercarriage, the hood, the dashboard, the trunk, a side mirror, and the like. Further, the sensors 105 can be in electronic communication with the software subsystem 110 (e.g., either directly via hardwiring or via the transceiver 125). Examples of sensors 105 can be, but are not limited to, cameras, radars, lidars, infrared (IR) cameras, thermal cameras, night-vision cameras, microphones, and the like.

The software subsystem 110 of the AV 100 can control certain functions of the AV 100. For example, the software subsystem 110 can receive sensory data from the sensors 105. In some cases, the software subsystem 110 can also activate the sensors 105, or instruct the sensors to collect certain sensory data (e.g., night vision data, thermal data, and the like).

The software subsystem 110 can also control the actuation subsystem 115. The actuation subsystem 115 can include components of the AV 100 that actuate the vehicle. For example, the actuation subsystem 115 can include a steering column, brakes, throttle, transmission, turn signals, horn, and the like. The software subsystem 110 can be in electronic communication with the actuation subsystem 115, and can send electronic commands or instructions to the actuation subsystem 115 for various components of the subsystem 115 to actuate the AV 100.

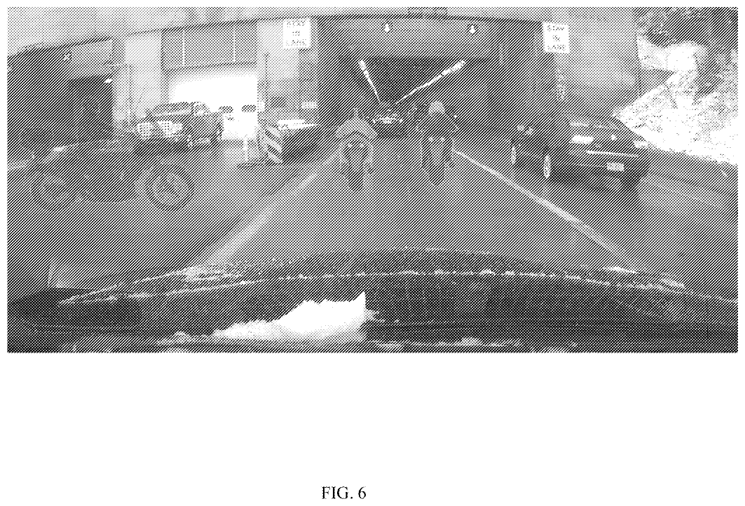

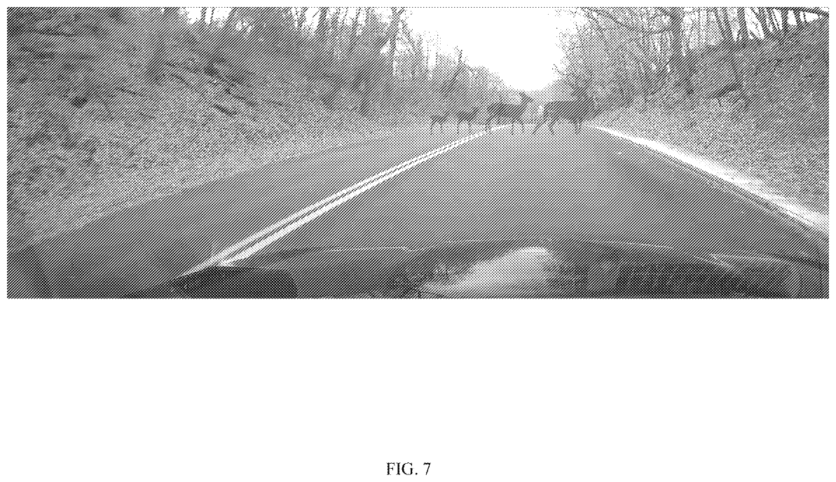

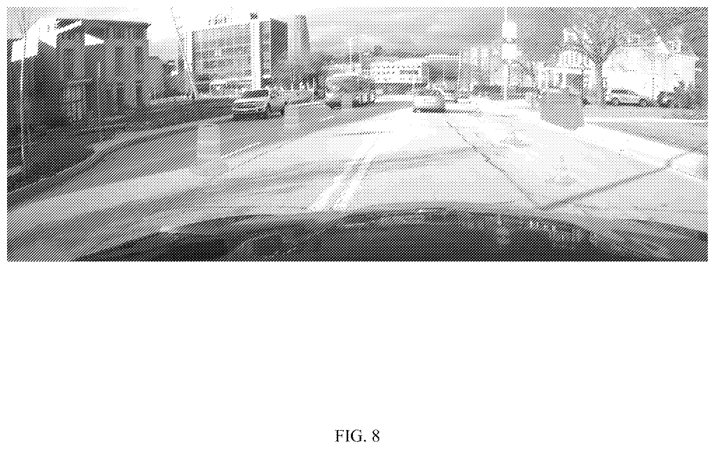

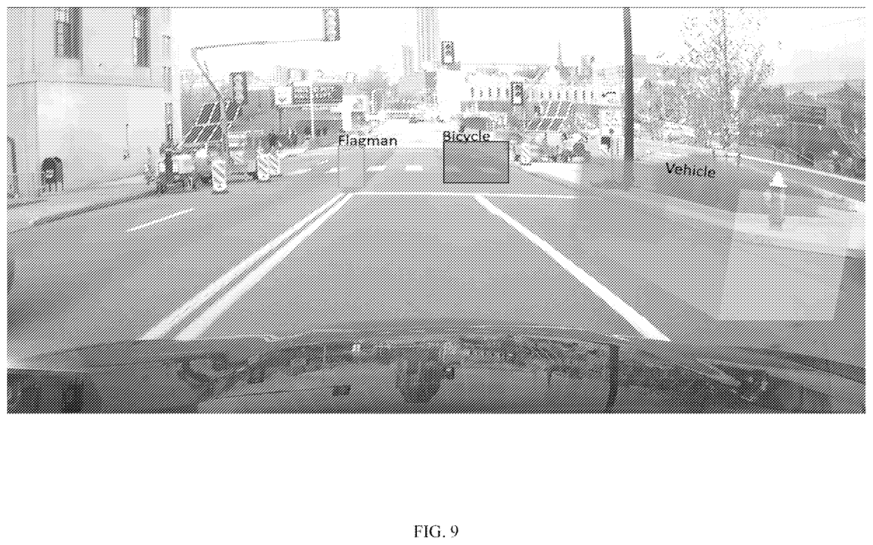

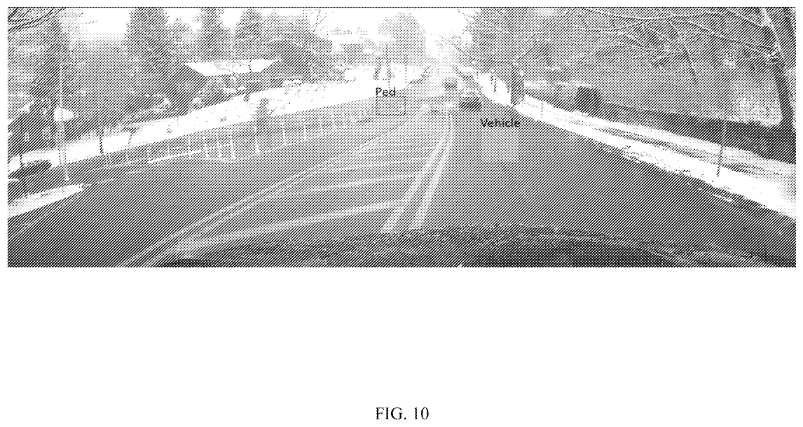

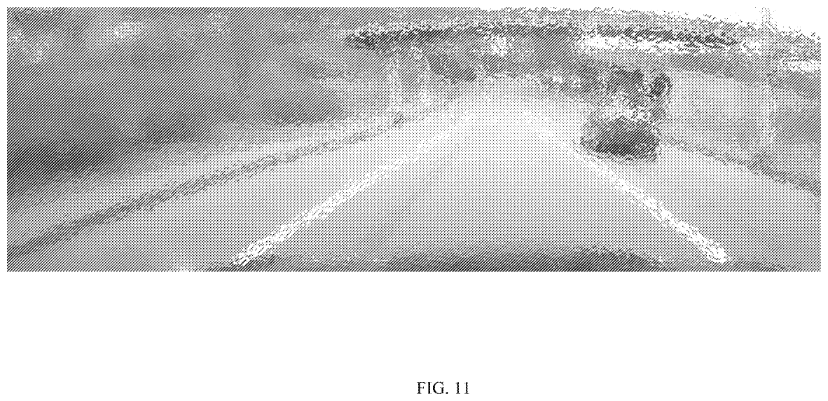

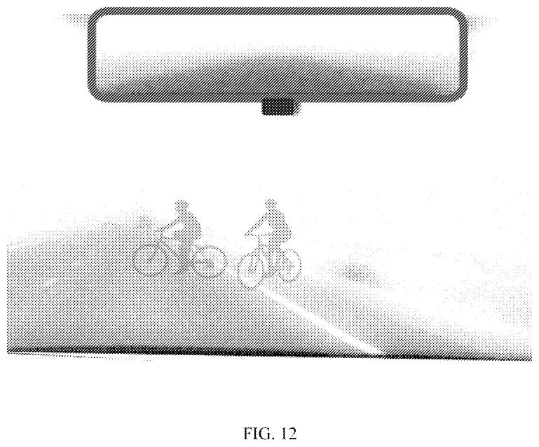

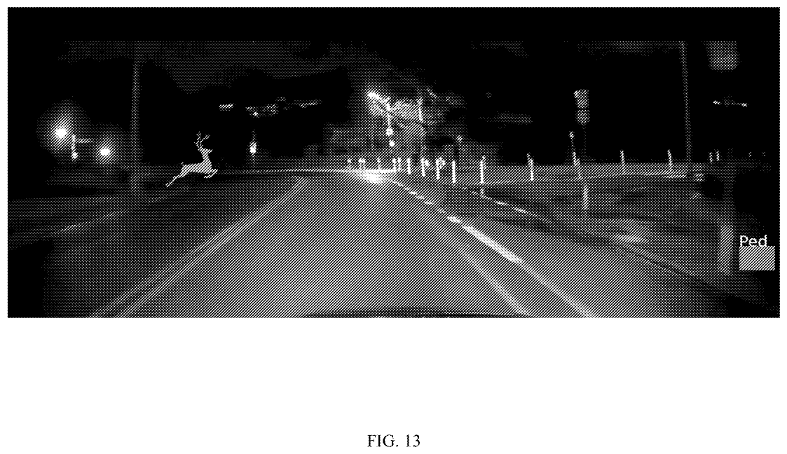

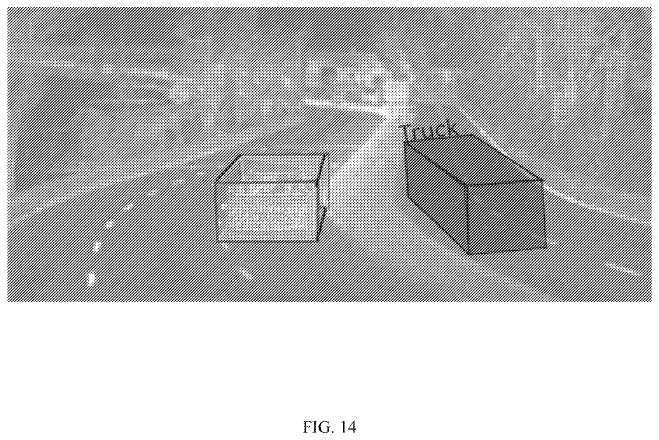

The software subsystem 110 can include one or more computers 120. FIG. 1 depicts two computers 120-a and 120-b, but more or fewer computers can be included in the software subsystem 115. The computers 120 can each include one or more of a central processing unit (CPU), a graphics processing unit (GPU), a machine learning accelerator, an image processing unit (IPU), a signal processor, and the like. In some cases, each computer 120 can be in electronic communication with the other computers 120, for example via the communication links 125. Thus, a computer 120 can function in series or in parallel with another computer 120. FIGS. 6 and 7 depict images of an AV and it surrounding environment, while FIGS. 8 and 9 depict interior views of an AV.

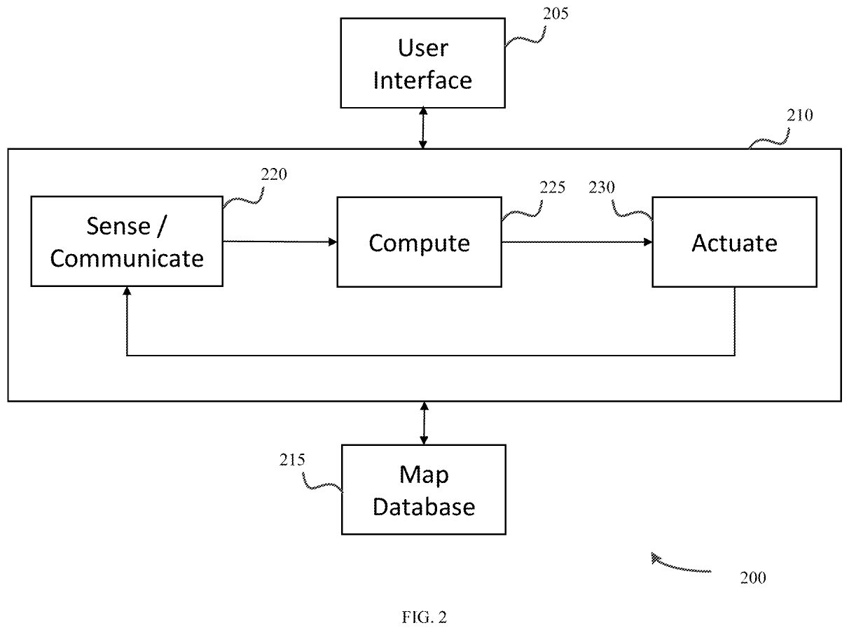

FIG. 2 depicts a software subsystem 200 according an embodiment of the claimed invention. The software subsystem 200 can be an example of the software subsystem 110 as described with reference to FIG. 1. The software subsystem can include a user interface 205, one or more computers 210, and may also include a map database 215.

The user interface 205 can be any component configured to receive user input and/or to provide information to the user. For example, the user interface 205 can be a display console configured to provide visual information to the user and/or to receive user input via a touchscreen, a keyboard, and the like. Other examples of a user interface can include a speaker configured to provide aural information to the user, a microphone configured to receive auditory commands, a console configured to generate tactile feedback, or a combination thereof. In some cases, the user input can be received via wireless communications, a touchscreen, a switch, a button, a knob, a keyboard, a computer mouse, a drawing pad, a camera, a microphone, and the like.

The one or more computers 210 can be in electronic communication with the user interface 205 and the map database 215. The computers 210 can perform various processes for the AV, including decision-making processes for the AV, the generation of actuation commands for the AV, analyses of the sensory information, and the like. For example, the computers 210 can include sense/communication processes 220, compute processes 225, and actuate processes 230.

The sense/communication processes 220 can include receiving and/or transmitting information from various sources external to the software subsystem 200. For example, the computers 210 can receive sensory data from one or sensors of the AV, such as from the sensors 105 as described in FIG. 1. In some cases, the computers 210 can receive communications, for example, from the user interface 205 or from the transceiver 125 (e.g., via wirelessly) as described in FIG. 1. The communications can be from a user, and can in some cases be instructions or commands from the user, or requests for information from the user.

The compute processes 225 can include processes corresponding to how the AV reacts to scenarios and/or the surrounding environment the AV is experiencing. For example, based on received sensory data, and/or communications received from a user, the computers 210 can determine car control decisions to react to the sensed data. In some cases, the AV can determine a reactive decisions based on identified characteristics and parameters of the sensory data received from sensors. In some cases, the computers 210 can receive feedback or instructions from a user, such as instructions for reacting to a particular situation or environment the AV is experiencing. As such, the computers 210 can in some cases compute how to implement the received instructions.

The actuate processes 230 can include processes for actuating the AV in response to the sense/communicate processes 220. For example, the AV can include a variety of actuators, for example, the actuators can include steering column, brakes, throttle, transmission, turn signals, and the like. The computers 210 can generate commands for actuating an actuator or actuators of the AV. For example, computers 210 can generate an actuation command such as an increase in AV speed (or speed limit), a decrease in AV speed (or speed limit), maintaining AV speed, instructing the AV to drive around one or more obstacles, instructing the AV to drive over or through one or more obstacles, a continuation of the AV in its current state, maintaining a stationary status until further notice, a gear selection of the AV, a horn initiation, an initiation of vehicle flashers, an emergency alert initiation, an unlocking or locking of a door of the AV, opening or closing of a window of the AV, a headlight initiation of the AV, a direction change of the AV, a route change of the AV, changes to a map used by the AV, a turn instruction for the AV, a lane change of the AV, a re-routing of the AV, a lateral offset in the travel direction of the AV, driving on a road shoulder, driving off-road, following a driving path specified in the operator command, driving over a shoulder, following a specified set of lanemarkers, sticking to a lane bordered by a specified set of workzone artifacts such as cones and barrels, yielding to other vehicles at an intersection, performing a zipper merge at a merge point, instructing the AV to take its turn, instructing the AV to merge, positioning the AV over to a shoulder of a road, stopping the AV, yielding to an emergency vehicle, requiring manual takeover of the AV, and the like.

The software subsystem 200 can optionally include a map database 215. The map database 215 can store a set of driving maps for the AV. For example, the map database 215 can store maps with roadways, along with geographical coordinates for the roadways and other points of interest. In some cases, the computers 210 can implement any of the sense/communication processes 220, the compute processes 225, and the actuate processes 230 utilizing the map data stored in the map database 215.

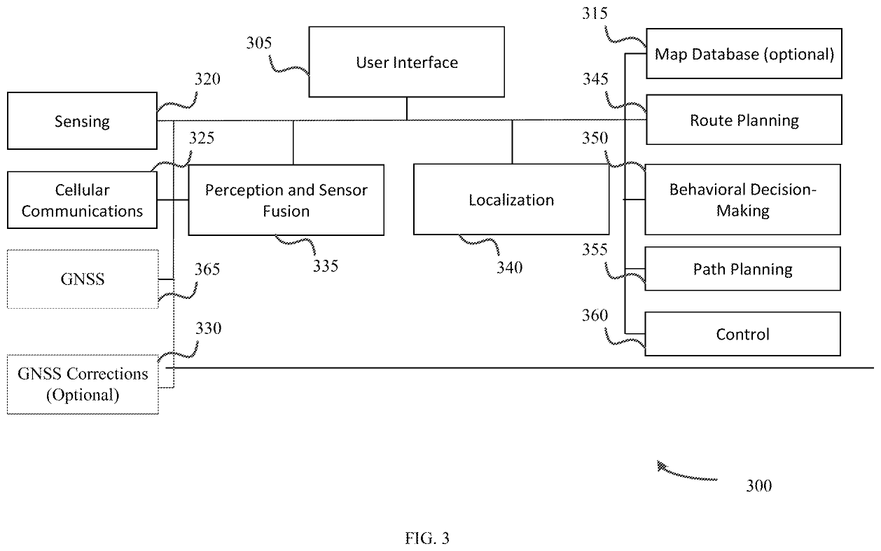

FIG. 3 depicts a software subsystem 300 according to an embodiment of the claimed invention. The software subsystem 300 can be an example of software subsystem 110 of FIG. 1, or software subsystem 200 of FIG. 2. The software subsystem 300 can include a user interface 305, an optional map database 315, a sensing component 320, a cellular communications component 325, an optional GNSS corrections component 330, a perception and sensor fusion component 335, a localization component 340, a route planning component 345, a behavioral decision-making component 350, a path planning component 355, a control component 360, and a GNSS component 365. However, one skilled in the art will understand that different architectures may be structured for implementing the functions described below, and fall within the scope of the disclosure.

The software subsystem 300 can include a user interface 305, which can be an example of the user interface 205 of FIG. 2. The software subsystem 300 can also include an optional map database 315, which can be an example of the map database 215 of FIG. 2.

The sensing component 320 can transmit and receive communications to and from the sensors of the AV, such as sensors 105 of FIG. 1. For example, the sensing component 320 can receive sensory data from sensors, and can transmit commands, instructions, feedback, acknowledgments, and the like, to the sensors.

The cellular communications component 325 can transmit and receive wireless

communications to and from the AV. For example, the cellular communications component 325 can transmit and receive commands, instructions, feedback, acknowledgments, sensory data, and the like, to a user, storage database, etc. In some cases, the cellular communications component 325 can receive or transmit communication from and to, or can be a part of, the transceiver 120 of FIG. 1.

The GNSS component 365 can, for example, receive GPS data from satellites pertaining to geographical coordinates of the AV. The GNSS corrections component 330 can analyze and correct satellite positions corresponding to the AV. For example, the GNSS corrections component 330 can receive a geographical position of the AV via satellite communications. The GNSS corrections component 330 can receive GNSS corrections parameters from a processing center, and can apply these correction parameters to received GNSS positioning data.

The perception and sensor fusion component 335 can receive sensory data and generate compiled data pertaining to the AV environment. For example, the perception and sensor fusion component 335 can receive sensory data from a variety of sensors (e.g., multiple cameras, GPS data, audio data, vehicle data, and the like). The perception and sensor fusion component 335 can compile this sensory data to generate aggregated sensory information, such as a panoramic view of a front-facing perspective of the AV, a side view while traversing an intersection, a rear view while backing up, or a rear side view while changing lanes, the location and type of the lanemakers and road boundaries, for example.

The localization component 340 can localize a position of the AV. For example, the localization component 340 can receive data from GNSS satellites for localizing the AV, receive and communicate with GNSS correction stations which in turn can be used to determine the position of the AV at a given time. In some cases, the localization component 340 can receive map data from the map database 315 and subsequently determine the position of the AV in relationship to the map data. In some other cases, the localization component 340 can receive data from the perception and sensor fusion component 335 to determine the position of the AV. In one embodiment of the invention, the localization component 340 can be part of the perception and sensor fusion component 335.

The route planning component 345 can plan a route that the AV can drive along. In some cases, the route is generated when the AV begins its current trip from a starting point to a destination specified by the user using the user interface component 305 or an local or remote user. In some cases, the route can be dynamically modified, for example, due to the detection of a road closure by the perception and sensor fusion component 335. In some other cases, the route can be modified when a shorter, faster or more energy-efficient route becomes available.

The behavior planning component 350 determines how the AV must drive towards its destination taking into account traffic rules and regulations, as well as current traffic conditions in the operating environment around the AV. For example, the behavior planning component can require that the AV come to a stop at a stop line at an upcoming intersection and take its turn, that the AV go through an intersection controlled by a traffic light which is currently green, that the AV continue through an intersection if the traffic light just turned yellow and there is not enough time or distance to come to a stop, that the AV come to a stop at a red traffic light, that the AV yield to merging traffic, that the AV go ahead of merging traffic, that the AV ought to change lanes, that the AV must make a turn at an intersection, that the current maximum speed of the AV is a certain value, and the like. The behavior planning component can take as its inputs data from the perception and sensor fusion component 335, the localization component 340, optionally the map database component 315, and/or the route generated by the route planning component 345. In some cases, the behavior planning component can determine its outputs based on the weather conditions, lighting conditions, road conditions and traffic conditions detected by the perception and sensor fusion component 335.

The path planning component 355 determines the speed at which the AV should drive at and the pathway the AV should follow in the immediate future, that can be up to several seconds. For example, the path planning component can receive the data from the perception and sensor fusion component 335 to determine whether there are any immediate obstacles on the road. The path planning component can read or receive data from the map database component 315 to determine where on the map the AV should be and how the AV should be oriented. The path planning component can receive data from the behavior decision-making component 350 to know the maximum speed to use, whether and when the AV needs to accelerate, slow down or come to a stop. The path planning component attempts to make forward progress while keeping the vehicle safe at all times, by generating the path and speed profiles for the AV in the near term.

In one embodiment of this invention, the route-planning component 345, the behavioral decision-making component 350, the path planning component 360, and the localization component 340, or various combinations thereof can constitute the compute component 225 in FIG. 2. In another embodiment of this invention, some compute functions of the control component 360 can also be part of the compute component 225 in FIG. 2.

The control component 360 sends commands to the actuators of the AV to drive the vehicle at the appropriate speed and direction. It can take its inputs for the desired speed and pathway from the path planning component and fulfils those requirements as quickly and comfortably as possible. The control component can also take optional inputs from the map database 345, the behavioral decision-making component 350, the localization component 340, and the perception and sensor fusion component 335. In one embodiment of this invention, the control component can issue commands to and read the status of the vehicle actuators in the actuators component 115 in FIG. 1. In another embodiment of this invention, the control component performs the functions of the actuate component 210 in FIG. 2.

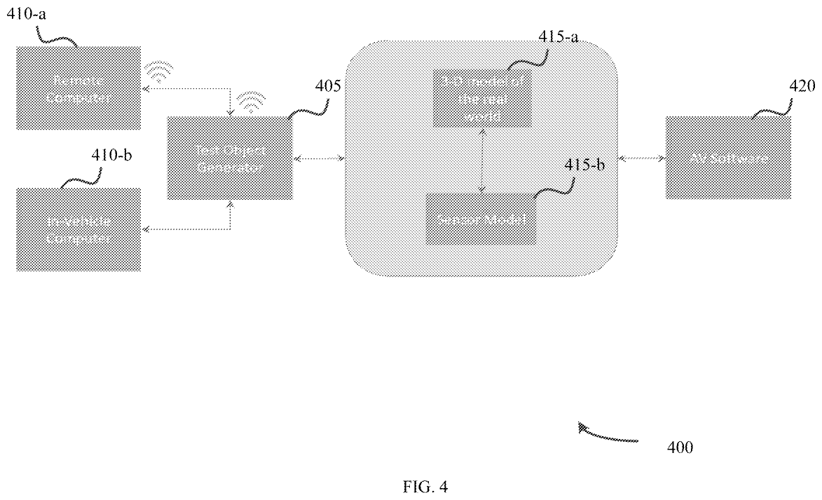

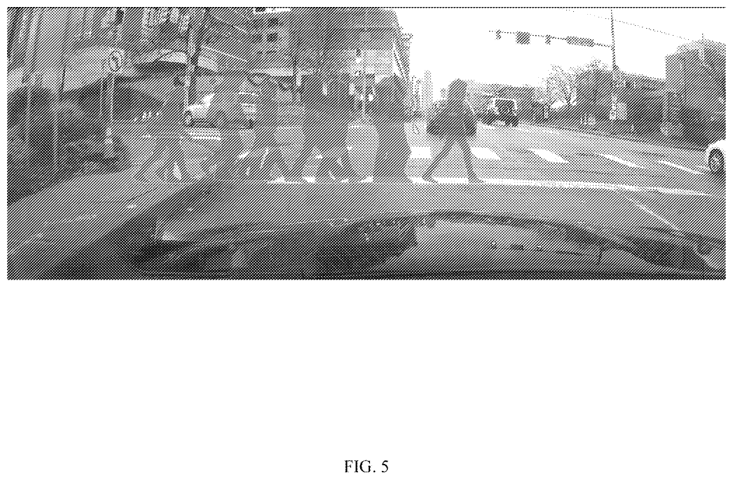

FIG. 4 depicts a subsystem 400 for superimposition of sensory data for an AV according to an embodiment of the claimed invention. The subsystem 400 can include a virtual object generator 405, computers 410, sensory data models 415, and AV software 420.

The test object generator 405 can generate test objects to be superimposed on the sensory datastreams of the AV. For example, the test object generator 405 can store or upload (e.g., from remote storage) a set of test objects. The test object generator 405 can retrieve one or more of these test objects from the storage. In some cases, the test object generator 405 can modify the virtual object via different characteristics of the object. For example, appearance, classification, a bounding box, dimensionality (that is, 2-d or 3-d), an outline, a location, a speed, a direction, partial or complete visibility, and the like, can be modified on the test object for superimposition.

In some cases, the set of attributes for a test object can be dependent on a function of time, location, relative distance from the AV, speed of the AV, direction of the AV, one or more other test objects in the vicinity, surrounding objects in the external environment, and the like.

Some example attributes that the test object generator can implement can include, but are not limited to, a time of birth on an absolute timeline; a time of birth on a relative timeline; a time of birth at an absolute position within the sensory data or external environment; a time of birth position within the sensory data or external environment relative to the AV; a time of birth at an absolute speed of movement; a time of birth at a speed of movement relative to a speed of the AV; a time of birth movement along an absolute direction; a time of birth movement along a direction relative to a direction of travel of the AV; a time of birth position relative to other objects; a time of demise on an absolute timeline; a time of demise on a relative timeline; a time of demise at an absolute location; a time of demise at a location relative to the AV; a time of demise at an absolute speed; a time of demise at a speed relative to a speed of the AV; a time of demise along an absolute direction, a time of demise along a direction relative to a direction of travel of the AV; a time of demise position relative to other objects, are-generation count for the test object; a frequency for re-generation of the test object; a movement status for the test object; a behavior pattern for the test object corresponding to other test objects; a behavior pattern for the test object relative to objects within the external environment; a behavior pattern for the test object relative to the AV, and the like.

Some examples of test objects that the test object generator 405 can generate and/or store can include, but is not limited to, a vehicle, a pedestrian, a bicyclist, a rider, an animal, a bridge, a tunnel, an overpass, a merge lane, a train, a railroad track, railway gates, a construction zone artifact, a construction zone worker, a roadway worker, a road boundary marker, a lane boundary marker, a road obstacle, a traffic sign, a road surface condition, a lighting condition, a weather condition, an intersection controller, a tree, a pole, a bush, a mailbox, and the like.

The test object generator 405 can be in electronic communication with sensory data models 415. For example, the subsystem 400 can include a 3-D model 415-a, a sensory model 415-b that can model different sensor types (e.g. cameras, night vision sensors, radars, lidars and ultrasonic sensors), although one skilled in the art will understand that different implementations of models 415 can exist.

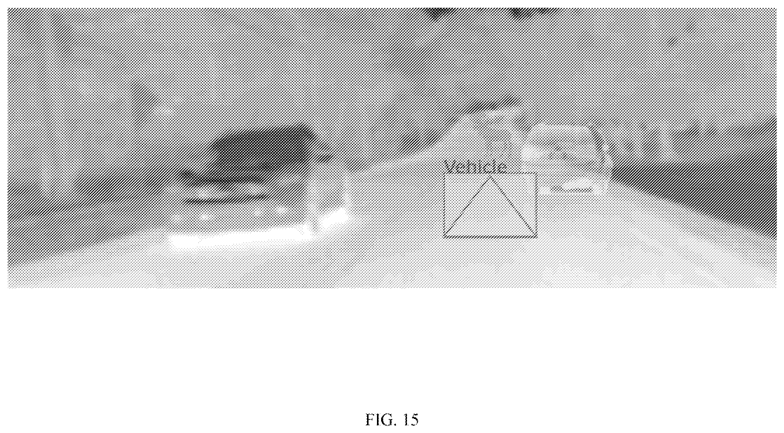

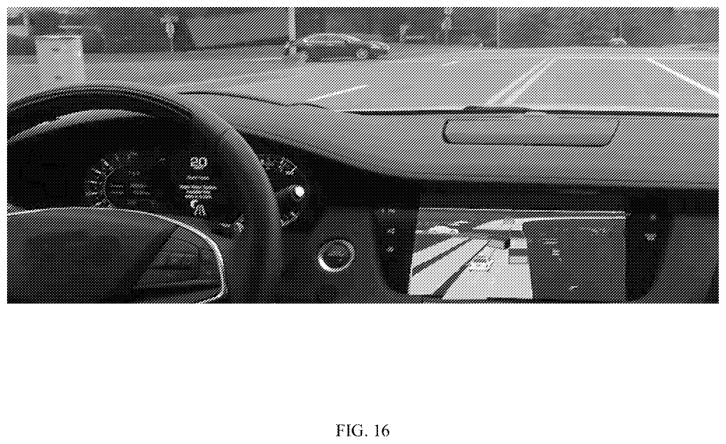

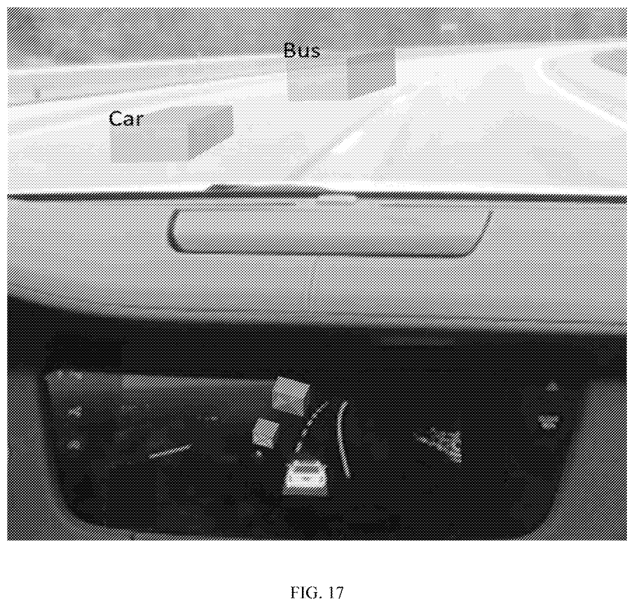

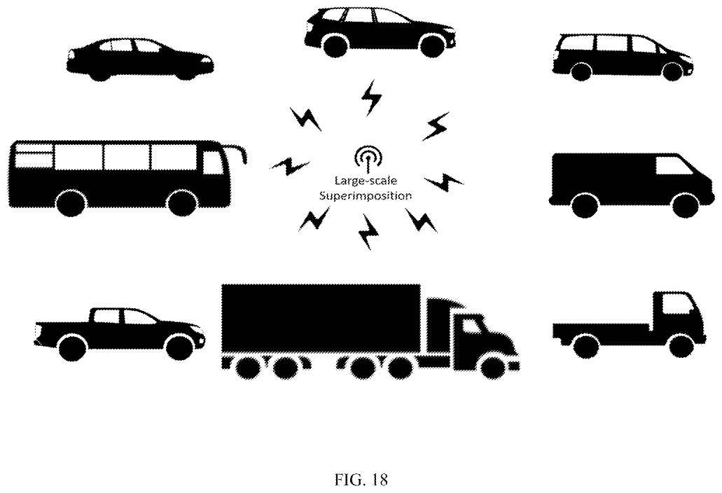

Both models 415-a and 415-b can receive sensory data from a set of sensors, such as sensors 105 discussed with reference to FIG. 1. 3-D model 415-a can receive this sensory data and generate a 3-dimensional model of the surrounding environment of the AV, such as the one shown on the center console screen of a vehicle in FIG. 15. The 3-D model 415-a can in some cases aggregate or stitch together a set of sensory data from different sensor types and sensors to form a partial or comprehensive 3-dimensional view of the AV's surrounding environment.

Likewise, the sensory model 415-b can receive sensory data and generate a superimposition of the test objects into the sensory datastreams of the AV. The sensory model 415-b can in some cases aggregate or stitch together a set of sensory data from different sensor types and sensors to form a partial or comprehensive view of the AV's proximal environment.

The test objects generated by the test object generator 405 can be communicated to the models 415-a and/or 415-b, which can superimpose the test objects onto the AV's sensory data streams. For example, the models 415 can in some cases determine positions to place the virtual objects, different characteristics for the virtual objects, predetermined motion for the virtual object, and the like. In some cases, these characteristics can be relayed as instructions or commands from the virtual object generator 405 or the computers 410.

The superimposed images can then be relayed to the AV software 420. The AV software 420 in some cases can be computer subsystem 110 discussed with reference to FIG. 1. The AV software 420 can analyze and process the superimposed images as if the AV was experiencing the virtual objects, as opposed to the virtual objects being superimposed with the sensory data. The AV software 420 can generate actuation commands in response to the superimposed data, which can be implemented via for example an actuation subsystem of the AV.

Thus, in some cases the AV can be trained using virtual objects, as opposed to just the AV's physical environment. For example, the AV software 420 can log and store event data corresponding to the software's decision-making processes, the sensory data the software reacted to, the superimposed virtual objects, and the like. If undergoing training, a user, such as a user of a computer 415, can monitor this event data, and verify, flag, or modify (e.g., via input to the computer 415) the decision-making process (e.g., verify a correct reaction, modify an incorrect reaction, etc.). The computer 415 can be remote (e.g., positioned external to the AV) or local (e.g., positioned within the AV), which can provide possibilities for a remote trainer or a local trainer.

In another case, the superimposed data can be generated for the AV to react in a predetermined way. For example, the virtual object generator can receive commands or instructions (e.g., via a computer 415) corresponding to recommended actions for the AV to undertake. For example, these recommended actions can include avoiding a location, driving towards a location, taking a specific route, driving at a certain speed, and the like. The virtual object generator can, based on these recommended actions, generate a virtual object for super-imposing onto the AV's sensory data. For example, if the recommended action is to avoid a route, the virtual object generator can generate a roadblock object for positioning across the roadway of the route to be avoided. The AV can detect this roadblock, and can react by changing course (e.g., taking another turn, turning around, etc.). In another example, the recommended action may be to take a particular route. The virtual object generator can generate a construction worker animated to wave the AV towards a particular direction. The AV can detect the construction works and the animated motion, and can actuate the car in response to the construction worker (e.g., towards the direction the construction worker is waving in).

In one embodiment of the invention, the test object generator 405, the 3-D model 415-a, the sensory model 415-b, or a combination thereof can be integrated into the AV software component 420. Likewise, these components can run on the in-vehicle computer 410-b. According to one embodiment of the invention, test objects to be generated can be pre-loaded into the test object generator before testing and training of the AV; test objects can be dynamically configured and loaded while the AV is being tested and trained; or a combination thereof. While the preferred embodiment of 3-D model 415-a is to visualize the real world in three dimensions, a 2-D version (e.g. one showing a “bird's eye view”) can also be realized.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A computer-implemented method for live testing an autonomous vehicle (AV) comprising:
generating one or more test objects from a stored set of test objects, test object attributes, or a combination thereof;
superimposing the one or more test objects on sensory data received from one or more sensors of the AV and corresponding to an external environment of the AV; and
testing one or more software subsystems of the AV, in a manual mode, a partially autonomous mode or a fully autonomous mode, with the sensory data after superimposition.

2. The computer-implemented method of claim 1, wherein each test object emulates raw sensory data, the output after the sensory data has been processed, or a combination thereof.

3. The computer-implemented method of claim 2, further comprising:
displaying, via one or more display interfaces of the AV, the sensory data; and
displaying, via the one or more display interfaces of the AV, the sensory data after superimposition of the test objects; or a combination thereof.

4. The computer-implemented method of claim 1, further comprising:
generating the one or more test objects from one or more computers located inside the AV, from one or more computers located outside the AV and communicating to the AV, or a combination thereof.

5. The computer-implemented method of claim 1, further comprising:
determining one or more positions within the sensory data, wherein the one or more test objects are each superimposed at a respective determined position.

6. The computer-implemented method of claim 1, wherein the one or more sensors comprise one or more vision cameras, one or more night vision cameras, one or more LIDARs, one or more RADARs, one or more ultrasonic sensors, one or more microphones, one or more vibration sensors, one or more locating devices, or a combination thereof.

7. The computer-implemented method of claim 1, further comprising:
incorporating a set of attributes of each test object into the superimposition, the set of attributes comprising an appearance, a classification, a bounding box, an outline, a location, a speed, a direction, partial or complete visibility, or a combination thereof.

8. The computer-implemented method of claim 7, further comprising:
determining the set of attributes of each test object as a function of time, location, relative distance from the AV, speed of the AV, direction of the AV, one or more other test objects in the vicinity, surrounding objects in the external environment, or a combination thereof.

9. The computer-implemented method of claim 1, wherein each test object comprises a vehicle, a pedestrian, a bicyclist, a rider, an animal, a bridge, a tunnel, an overpass, a merge lane, a train, a railroad track, railway gates, a construction zone artifact, a construction zone worker, a roadway worker, a road boundary marker, a lane boundary marker, a road obstacle, a traffic sign, a road surface condition, a lighting condition, a weather condition, an intersection controller, a tree, a pole, a bush, a mailbox, of a combination thereof.

10. The computer-implemented method of claim 1, wherein testing one or more AV software subsystems further comprises:
determining, by the one or more software subsystems, an identification of at least one of the one or more test objects;
determining, by the one or more software subsystems, a position of the at least one test object within the superimposed sensory data, the external environment, or a combination thereof; and
determining, by the one or more software subsystems, a future trajectory of the test object within the sensory data after superimposition, the real-world environment, or the combination thereof.

11. The computer-implemented method of claim 10, further comprising:
generating one or more actuation commands for one or more actuation subsystems of the AV based on the determined identification, the determined position, the determined trajectory, or a combination thereof; and
storing the one or more actuation commands generated by the one or more AV software subsystems.

12. The computer-implemented method of claim 10, further comprising:
storing, checking, verifying, validating, or a combination thereof, a set of decision processes undertaken by the one or more software subsystems during the testing.

13. The computer-implemented method of claim 1, further comprising:
determining a set of attributes for the one or more test objects; wherein the set of attributes comprise a time of birth on an absolute timeline, a time of birth on a relative timeline, a time of birth at an absolute position within the sensory data or external environment, a time of birth position within the sensory data or external environment relative to the AV; a time of birth at an absolute speed of movement; a time of birth at a speed of movement relative to a speed of the AV; a time of birth movement along an absolute direction; a time of birth movement along a direction relative to a direction of travel of the AV; a time of birth position relative to other objects; a time of demise on an absolute timeline; a time of demise on a relative timeline; a time of demise at an absolute location; a time of demise at a location relative to the AV; a time of demise at an absolute speed; a time of demise at a speed relative to a speed of the AV; a time of demise along an absolute direction, a time of demise along a direction relative to a direction of travel of the AV; a time of demise position relative to other objects, a number of re-generation for the test object; a frequency for re-generation of the test object, a movement status for the test object, a behavior pattern for the test object corresponding to other test objects, a behavior pattern for the test object relative to objects within the external environment, a behavior pattern for the test object relative to the AV, or a combination thereof.

14. The computer-implemented method of claim 1, wherein the sensory data comprise a front view from the AV, one or both side views from the AV, a rear view from the AV, or a combination thereof.

15. A non-transitory, computer-readable media of an autonomous vehicle (AV), comprising:
one or more processors;
a memory; and
code stored in the memory that, when executed by the one or more processors, cause the one or more processors to:
display, via one or more display interfaces of the AV, sensory data received from one or more sensors of the AV;
generate one or more test objects from a stored set of test objects or test object attributes;
superimpose the test object on the sensory data; and
test one or more software subsystems of the AV with the superimposed sensory data.

16. A computer-implemented method for super-imposing data of an autonomous vehicle (AV), comprising:
receiving sensory data from the AV;
receiving, in response to the sensory data, an operator command for altering AV driving behavior, route, path, speed, vehicle status, or a combination thereof;
generating, in response to the operator command, one or more test objects from a stored set of test objects, test object attributes, or a combination thereof; and
super-imposing the one or more test objects on the sensory data.

17. The computer-implemented method of claim 16, further comprising:
receiving the operator command from a remote operator station, an occupant of the AV, or a combination thereof.

18. The computer-implemented method of claim 16, wherein receiving the operator command comprises receiving input via an input interface comprising a wireless communications interface, a touchscreen, a switch, a button, a knob, a keyboard, a computer mouse, a drawing pad, a camera, a microphone, or a combination thereof.

19. A computer-implemented method to test and instruct one or more autonomous vehicles (AVs) comprising:
transmitting to a plurality of AVs a first set of route information where test objects may require superimposition on to sensory datastreams of the plurality of AVs;
receiving from one or more AVs a second set of route information;
determining from the second set of route information a group of AVs subject to at least one test object that requires superimposition on the respective AV's sensory datastreams; and
broadcasting to the group of AVs a list of data objects that must be superimposed based on the determining.

20. A computer-implemented method for testing and transmitting instructions to an autonomous vehicle (AV) from one or more remote computers, comprising:
transmitting to one or more remote computers route information of the AV;
receiving instructions to superimpose test objects based on the route information; and
processing the instructions to superimpose test objects as specified.

21. A computer-implemented method for testing and transmitting instructions to an autonomous vehicle (AV) from one or more remote computers, comprising:
receiving from the one or more remote computers one or more requests for AV route information;
transmitting to the one or more remote computers route information of the AV;
receiving instructions to superimpose test objects; and
processing the remote instructions to superimpose the test objects as specified.
